(19) United States
(12) Patent Application Publication
(10) Pub. No.: US 2020/0030754 A1
(43) Pub. Date: Jan. 30, 2020

(54) MICROPOROUS POLYOLEFIN MEMBRANE, MULTILAYER MICROPOROUS POLYOLEFIN MEMBRANE, LAMINATED MICROPOROUS POLYOLEFIN MEMBRANE AND SEPARATOR

(71) Applicant: Toray Industries, Inc., Tokyo (JP)

(72) Inventors: Takashi Kubota, Nasushiobara (JP); Toshihiko Kaneda, Nasushiobara (JP); Yanzi Chen, Nasushiobara (JP)

(21) Appl. No.: 16/488,176

(22) PCT Filed: Mar. 5, 2018
(86) PCT No.: PCT/JP2018/008336

§ 371 Date: Aug. 22, 2019

(30) Foreign Application Priority Data
Mar. 8, 2017 (JP) 2017-044211

(51) Int. Cl. B01D 71/26; H01M 2/16; B01D 67/00

(52) U.S. Cl. CPC B01D 71/26; H01M 2/1653; B01D 2325/24; B01D 2325/02; B01D 67/0088

(57) ABSTRACT

A polyolefin microporous membrane in which defects including scratches and pinholes can be stably detected, even when the membrane has a reduced thickness, has a light transmittance at a wavelength of 660 nm of 40% or less, and satisfies at least one of the following properties (1) and (2), wherein (1) the basis weight is 3.0 g/m² or less, and (2) the membrane thickness is 4 μm or less.

### TECHNICAL FIELD

This disclosure relates to a polyolefin microporous membrane, a multilayer polyolefin microporous membrane, a laminated polyolefin microporous membrane, and a separator.

### BACKGROUND

Microporous membranes are used in various fields, for example, filters such as filtration membranes and dialysis membranes, and separators such as battery separators and separators for electrolytic capacitors. Among these, polyolefin microporous membranes containing a polyolefin as a main component are widely used as secondary battery separators in recent years since such membranes exhibit an excellent chemical resistance, electrical insulation, mechanical strength and the like, as well as having a shut-down property.

Secondary batteries, for example, lithium ion secondary batteries are widely used as batteries for use in personal computers, mobile phones and the like because of their high energy density. Further, secondary batteries are also considered promising as power supplies for driving motors of electric cars and hybrid cars.

With an increase in electrode size due to a further increase in the energy density of secondary batteries in recent years, a further reduction in thickness is required for polyolefin microporous membranes to be used as separators. In addition, such polyolefin microporous membranes are also required to have a higher porosity to achieve improved ion permeability. However, as polyolefin microporous membranes have an increasingly reduced thickness and higher porosity, the strength of the membranes tends to decrease, and defects such as scratches and pinholes are more likely to occur.

The defects such as scratches and pinholes included in polyolefin microporous membranes are usually detected by an optical defect inspection using transmitted light. This enables prevention of polyolefin microporous membranes from having defects from being used as battery separators. However, light transmittance increases in polyolefin microporous membranes having a reduced thickness and a higher porosity, making it difficult to stably detect defects such as scratches and pinholes by a conventional optical defect inspection.

On the other hand, several evaluations of microporous membranes based on their light transmittance have been disclosed. For example, JP 2001-96614 A discloses a biaxially oriented film made of high molecular weight polyethylene and having a light transmittance of 10% or less. JP 2003-253026 A discloses a polyolefin microporous membrane having a total light transmittance of 33% or less. Further, JP 2014-09165 A discloses an aromatic polyamide porous membrane having a light transmittance at a wavelength of 750 nm of 20 to 80%, and a light transmittance at a wavelength of 550 nm of 20 to 80%.

Light transmittance markedly increases in a polyolefin microporous membrane having a reduced thickness or a higher porosity, particularly in a polyolefin microporous membrane having a membrane thickness of 4 μm or less, or a basis weight of 3.0 g/m² or less. In such a polyolefin microporous membrane, it is more difficult to achieve a stable detection of defects such as scratches and pinholes by a conventional optical defect inspection.

It could therefore be helpful to provide a polyolefin microporous membrane in which defects such as scratches and pinholes can be stably detected, even when the membrane has a reduced thickness or a higher porosity and a separator using the same.

### SUMMARY

We found that the light transmittance markedly increases in a polyolefin microporous membrane having a membrane thickness of 4 μm or less or a basis weight of 3.0 g/m² or less and, further, that the light transmittance at 660 nm is important as a film property in such a polyolefin microporous membrane.

We thus provide:

A polyolefin microporous membrane having a light transmittance at a wavelength of 660 nm of 40% or less, and satisfies at least one of (1) and (2):
(1) the basis weight is 3.0 g/m² or less; and
(2) the membrane thickness is 4 μtm or less.

The polyolefin microporous membrane may have a pin puncture strength per 1 g/m² of basis weight of 0.75 N or more. Further, the polyolefin microporous membrane may contain 50% by mass or more of polyethylene. Still further, the polyolefin microporous membrane may have a tensile strength in the MD direction of 240 MPa or more, and a tensile elongation in the MD direction of 50% or more.

A multilayer polyolefin microporous membrane includes, as at least one layer thereof, the polyolefin microporous membrane described above.

A laminated polyolefin microporous membrane includes: the above described polyolefin microporous membrane; and one or more coating layers provided on at least one surface of the microporous membrane.

A battery includes a separator including the above described polyolefin microporous membrane, the above described multilayer polyolefin microporous membrane, or the above described laminated polyolefin microporous membrane.

In the polyolefin microporous membrane, defects such as scratches and pinholes can be stably detected even when the membrane has a reduced thickness or a higher porosity.

### DETAILED DESCRIPTION

Examples will now be described. It is noted, however, that this disclosure is in no way limited to the examples to be described below.

### 1. Polyolefin Microporous Membrane

The term “polyolefin microporous membrane” is used to refer to a microporous membrane containing a polyolefin as a main component and refers, for example, to a microporous membrane containing 90% by mass or more of a polyolefin with respect to the total amount of the microporous membrane. The physical properties of a polyolefin microporous membrane will now be described.

The polyolefin microporous membrane satisfies at least one of (1) and (2):
(1) the basis weight is 3.0 g/m² or less; and
(2) the membrane thickness is 4 μm or less.

When a conventionally known polyolefin microporous membrane satisfies at least one of the above described properties, the light transmittance of the membrane is markedly increased. In such a polyolefin microporous membrane having an increased light transmittance, it is difficult to achieve stable detection of defects such as scratches and pinholes by a conventional optical defect inspection. In contrast, when the polyolefin microporous membrane satisfies at least one of (1) and (2), it is possible to detect scratches and pinholes accidentally formed during the film formation process of the microporous membrane. We found that a microporous membrane satisfying the above described (1) and (2) can be obtained by controlling the conditions in the kneading step of the polyolefin, as well as draw ratios in wet stretching and dry stretching.

### Light Transmittance at Wavelength of 660 nm

The light transmittance varies depending on the wavelength of light. The use of light with a shorter wavelength leads to a higher occurrence of scattered light and, thus, a decrease in light transmittance. In using light with a longer wavelength, the light transmittance is decreased due to the effect of the polyolefin having an infrared absorption. The polyolefin microporous membrane has a light transmittance at a wavelength of 660 nm of 40% or less. When the light transmittance (at a wavelength of 660 nm) is within the above described range, in the polyolefin microporous membrane having a basis weight of 3.0 g/m² or less or a membrane thickness of 4 μm or less, defects such as scratches and pinholes in the membrane can be stably detected by a conventional optical defect inspection.

When a polyolefin microporous membrane is used as a battery separator, a decrease in insulation resistance may occur at a location in the separator where a defect such as a scratch or a pinhole exists. Since defects such as scratches and pinholes can be easily detected in the polyolefin microporous membrane, a microporous membrane having a defect can be prevented from being used in a battery and, thus, a short circuit is less likely to occur during production and use of a battery including the polyolefin microporous membrane. The lower limit of the light transmittance at a wavelength of 660 nm is a value greater than 0.0%, and preferably 0.1% or more. When the light transmittance at a wavelength of 660 nm is 0.0%, defects such as the presence of foreign substances and protrusions cannot be easily detected and, thus, a polyolefin microporous membrane having a defect may be used as a battery separator, possibly causing an adverse effect on the produced battery such as contamination with foreign substances.

The light transmittance at a wavelength of 660 nm can be measured using various types of light sources. For example, a laser light source is preferred, and specifically, a transmission type laser discrimination sensor, IB-30 (laser wavelength: 660 nm) manufactured by Keyence Corporation, can be used for the measurement.

The light transmittance at a wavelength of 660 nm can be controlled within the above described range, for example, by adjusting the kneading conditions and the draw ratios in the production of the polyolefin microporous membrane.

### Membrane Thickness

The polyolefin microporous membrane preferably has a membrane thickness of 6 or less, more preferably 5.5 μm or less, and still more preferably 4 μm or less. The lower limit of the membrane thickness is, for example, 1 μm or more, but not particularly limited thereto. When the polyolefin microporous membrane has a membrane thickness within the above described range, and when the membrane is used as a battery separator, the size of electrodes can be increased, allowing for an improved battery capacity. The polyolefin microporous membrane has a high membrane strength, and is less susceptible to defects such as scratches and pinholes, even when the membrane has a reduced thickness.

### Basis Weight

The polyolefin microporous membrane preferably has a basis weight of 3.0 g/m² or less. The lower limit of the basis weight is, for example, 1.0 g/m² or more, but not particularly limited thereto. In a polyolefin microporous membrane having a certain membrane thickness, a higher porosity results in a lower basis weight. When the polyolefin microporous membrane has a basis weight within the above described range, and when the membrane is used as a battery separator, the amount of electrolytic solution to be retained per unit volume can be increased to ensure a high ion permeability. The basis weight of the polyolefin microporous membrane can be controlled within the above described range by adjusting the blending ratio of the constituent components of the polyolefin resin, the draw ratios and the like in the production process. The basis weight of the polyolefin microporous membrane as used herein refers to the weight of 1 m² of the polyolefin microporous membrane.

### Pin Puncture Strength

The polyolefin microporous membrane preferably has a pin puncture strength per 1 g/m² of basis weight of 0.75 N or more, and more preferably 0.80 N or more. In the polyolefin microporous membrane having a pin puncture strength per 1 g/m² of basis weight within the above described range, it is possible to prevent the occurrence of defects such as pinholes and scratches after completion of a pinhole inspection. When the polyolefin microporous membrane is used as a battery separator, it is possible to drastically reduce the risk of the occurrence of scratches and pinholes in the separator during the production process of a battery, and to obtain a battery in which the occurrence of a short circuit between electrodes and self-discharge are prevented. As a result, it is possible to prevent the occurrence of a short circuit between electrodes and self-discharge, as described above. The pin puncture strength can be controlled within the above described range, for example, by incorporating ultra-high molecular weight polyethylene, or adjusting the weight average molecular weight (Mw) of the polyolefin resin included in the polyolefin microporous membrane and the draw ratios (in particular, the draw ratio of the film after drying, which is to be described later), in the production of the polyolefin microporous membrane.

Further, the pin puncture strength of the polyolefin microporous membrane (the entire membrane) is preferably 1.5 N or more, and more preferably 1.8 N or more, but not particularly limited thereto. The upper limit of the pin puncture strength is, for example, 10.0 N or less, but not particularly limited thereto.

The pin puncture strength as used herein refers to a value obtained by measuring the maximum load (N), when the polyolefin microporous membrane having a membrane thickness T₁ (μm) is punctured with a needle having a diameter of 1 mm and having a spherical tip (curvature radius R: 0.5 mm) at a speed of 2 mm/sec.

### Tensile Strength

The lower limit of the tensile strength in the MD direction of the polyolefin microporous membrane is preferably 240 MPa or more, and more preferably 270 MPa or more (2800 kgf/cm² or more). The upper limit of the tensile strength in the MD direction is, for example, 500 MPa or less, but not particularly limited thereto. When the tensile strength is within the above described range, the polyolefin microporous membrane has a high durability, and is less likely to rupture even if a high tension is applied to the membrane. For example, when a microporous membrane having a tensile strength within the above described range is used as a battery separator, the occurrence of a short circuit can be prevented during the production or use of a battery including the separator and, at the same time, the separator can be wound while applying a high tension thereto, thereby allowing for an increase in the capacity of the battery. Further, in the step of coating a coating layer or the like on at least one surface of the polyolefin microporous membrane, the occurrence of coating failure and the like can be prevented.

The lower limit of the tensile strength in the TD direction of the polyolefin microporous membrane is, for example, 100 MPa or more, preferably 180 MPa or more, and more preferably 210 MPa or more, but not particularly limited thereto. The upper limit of the tensile strength in the TD direction is, for example, 500 MPa or less, but not particularly limited thereto. Further, in the polyolefin microporous membrane, the lower limit of the ratio (MD tensile strength/TD tensile strength) of the tensile strength in the MD direction relative to the tensile strength in the TD direction is preferably 0.8 or more, and more preferably 1.0 or more. The upper limit of the ratio of the tensile strength in the MD direction relative to the tensile strength in the TD direction is preferably 1.6 or less, and more preferably 1.5 or less.

When at least one of the TD tensile strength of the polyolefin microporous membrane and the ratio of the MD tensile strength relative to the TD tensile strength is within the above described range, the polyolefin microporous membrane has an excellent tensile strength and, thus, can be suitably used in an application in which a high strength and durability are required. Since separators are usually wound in the MD direction, the ratio of the MD tensile strength relative to the TD tensile strength is preferably within the above described range.

The MD tensile strength and the TD tensile strength as used herein refer to values measured by a method in accordance with ASTM D882.

### Tensile Elongation

The polyolefin microporous membrane has a tensile elongation in the TD direction of, for example, 50% or more and 300% or less, and preferably 100% or more. When the polyolefin microporous membrane has a TD tensile elongation within the above described range, and when the polyolefin microporous membrane is used as a separator, the separator can conform to the irregularities of electrodes, the deformation of the resulting battery, the occurrence of internal stress due to heat generation in the battery and the like. Therefore, such a TD tensile elongation is preferred.

The polyolefin microporous membrane has a tensile elongation in the MD direction of, for example, 50% or more, preferably 50% or more and 300% or less, and more preferably 50% or more and 100% or less. The MD tensile elongation and the TD tensile elongation as used herein refer to values measured by a method in accordance with ASTM D-882A.

### Air Permeability

The polyolefin microporous membrane has an air permeability of, for example, 30 sec/100 cm³ or more and 300 sec/100 cm³ or less, but not particularly limited thereto. The upper limit of the air permeability when the polyolefin microporous membrane is used as a battery separator is preferably 250 sec/100 cm³ or less, and more preferably 150 sec/100 cm³ or less. When the polyolefin microporous membrane has an air permeability within the above described range, and when the membrane is used as a battery separator, an excellent ion permeability, a lower battery impedance, and an improved battery output can be achieved. The air permeability can be controlled within the above described range by adjusting the stretching conditions in the production of the polyolefin microporous membrane and the like.

### Porosity

The polyolefin microporous membrane has a porosity of, for example, 10% or more and 70% or less, but not particularly limited thereto. When the polyolefin microporous membrane is used as a battery separator, the membrane preferably has a porosity of 20% or more and 60% or less, and more preferably 20% or more and 50% or less. When the porosity is within the above described range, it is possible to ensure a high amount of electrolytic solution retained and a high ion permeability, and improve the rate characteristics of the resulting battery. The porosity can be controlled within the above described range by adjusting the blending ratio of the constituent components of the polyolefin resin, the draw ratios and the like in the production process.

### Heat Shrinkage

The polyolefin microporous membrane has a heat shrinkage in the MD direction as measured at 105° C. for 8 hours of, for example, 10% or less, and preferably 6% or less, and more preferably 4% or less. The polyolefin microporous membrane has a heat shrinkage in the TD direction of, for example, 10% or less, preferably 8% or less, and more preferably 6% or less.

### Mean Flow Diameter

The polyolefin microporous membrane has a mean flow diameter of, for example, 60 nm or less, and more preferably 50 nm or less.

The mean flow diameter of the polyolefin microporous membrane as used herein refers to a value measured by a method in accordance with ASTM F316-86.

### Composition

The polyolefin microporous membrane contains a polyolefin resin as a main component. Examples of the polyolefin resin which can be used include polyethylene and polypropylene. The polyolefin microporous membrane can contain, for example, 50% by mass or more of polyethylene with respect to the total amount of the polyolefin microporous membrane. The polyethylene is not particularly limited, and various types of polyethylenes can be used. Examples of the polyethylene to be used include high density polyethylene, medium density polyethylene, branched low density polyethylene and linear low density polyethylene. The polyethylene may be a homopolymer of ethylene, or may be a copolymer of ethylene with another α-olefin. Examples of the α-olefin include propylene, butene-1, hexene-1, pentene-1, 4-methylpentene-1, octene, vinyl acetate, methyl methacrylate and styrene.

When the polyolefin microporous membrane contains high density polyethylene (density: 0.920 g/m³ or more and 0.970 g/m³ or less), an excellent melt extrudability and uniform stretchability can be obtained. The weight average molecular weight (Mw) of the high density polyethylene to be used as a raw material is, for example, about 1×10⁴ or more and less than 1×10⁶. The Mw as used herein refers to a value measured by gel permeation chromatography (GPC). The content of the high density polyethylene is, for example, 50% by mass or more, with respect to 100% by mass of the total amount of the polyolefin resin. The upper limit of the content of the high density polyethylene is, for example, 100% by mass or less, and the upper limit thereof when containing any other components is, for example, 90% by mass or less.

Further, the polyolefin microporous membrane can contain ultra-high molecular weight polyethylene (UHMwPE). The ultra-high molecular weight polyethylene to be used as a raw material has a weight average molecular weight (Mw) of 1×10⁶ or more, and preferably 1×10⁶ or more and 8×10⁶ or less. When the Mw is within the above described range, an improved moldability can be obtained. The Mw as used herein refers to a value measured by gel permeation chromatography (GPC). One type of ultra-high molecular weight polyethylene can be used alone, or two or more types thereof may be used in combination. For example, two or more types of ultra-high molecular weight polyethylenes having different Mws may be used as a mixture.

The ultra-high molecular weight polyethylene can be contained, for example, in an amount of 2% by mass or more and 70% by mass or less, with respect to 100% by mass of the total amount of the polyolefin resin. For example, when the content of the ultra-high molecular weight polyethylene is 10% by mass or more and 60% by mass or less, the Mw of the resulting polyolefin microporous membrane can be easily controlled within a specific range to be described later, and an excellent productivity such as excellent extrusion kneading characteristics, tends to be obtained. Further, when the ultra-high molecular weight polyethylene is contained, a high mechanical strength can be obtained even when the polyolefin microporous membrane has a reduced thickness.

The polyolefin microporous membrane may contain polypropylene. The type of the polypropylene is not particularly limited, and the propylene may be any of a homopolymer of propylene, a copolymer of propylene with another α-olefin and/or diolefin, and a mixture thereof. However, it is preferred to use a propylene homopolymer from the viewpoint of improving the mechanical strength, reducing the through pore size and the like. The content of the polypropylene with respect to the total amount of the polyolefin resin is, for example, 0% by mass or more 15% and by mass or less. From the viewpoint of improving the heat resistance, the content of the polypropylene is preferably 2.5% by mass or more and 15% by mass or less.

Further, polyolefin microporous membrane can contain another resin component other than polyethylene and polypropylene, if necessary. The other resin component may be, for example, a heat resistant resin or the like. The polyolefin microporous membrane may also contain any of various types of additives such as, for example, an antioxidant, a thermal stabilizer, an antistatic agent, a UV absorber, an antiblocking agent, a filler, a crystal nucleating agent and/or a crystallization retarder as long as the desired effect is not impaired.

### Weight Average Molecular Weight: Mw

The polyolefin microporous membrane has a weight average molecular weight (Mw) of, for example, 3×10⁵ or more and less than 2 ×10⁶. When the Mw is within this range, an excellent moldability, mechanical strength and the like can be obtained. In addition, it is possible to prevent the occurrence of a localized stress conversion and to allow the formation of a uniform and fine pore structure, even when the polyolefin microporous membrane is stretched at a relatively high draw ratio in the production process of the membrane. The Mw of the polyolefin microporous membrane can be controlled within the above described range by adjusting the blending ratio of the constituent components of the polyolefin resin and melt-kneading conditions, as appropriate. The Mw of the polyolefin microporous membrane as used herein refers to a value measured by gel permeation chromatography (GPC).

Further, the weight fraction of the polyolefin having a molecular weight of 5×10⁵ or more, in the polyolefin microporous membrane, is preferably 5% or more. When the weight fraction of the polyolefin having a molecular weight of 5×10⁵ or more is within the above described range, the polyolefin microporous membrane has an excellent membrane strength, and it is possible to achieve a light transmittance at a wavelength of 660 nm of 40% or less.

### 2. Method of Producing Polyolefin Microporous Membrane

The method of producing the polyolefin microporous membrane is not particularly limited as long as a polyolefin microporous membrane having the above described properties can be obtained, and it is possible to use a known method of producing a polyolefin microporous membrane. The polyolefin microporous membrane can be produced, for example, by a dry film formation method or a wet film formation method. From the viewpoint of facilitating the control of the structure and physical properties of the resulting membrane, the polyolefin microporous membrane is preferably produced by a wet film formation method. For example, any of the methods disclosed in JP 2132327 B and JP 3347835 B, WO 2006/137540 and the like can be used as the wet film formation method.

One example of the method of producing the polyolefin microporous membrane will be described below. However, the following description is one example of the production method, and this disclosure is not limited to the method described below.

First, a polyolefin resin and a membrane-forming solvent are melt-kneaded to prepare a resin solution. The melt-kneading can be carried out, for example, by a method using a twin screw extruder such as those described in the specifications of JP 2132327 B and JP 3347835 B. Since melt-kneading methods are well known, the description thereof is omitted.

The polyolefin resin preferably contains high density polyethylene. When the polyolefin resin contains high density polyethylene, an excellent melt extrudability and uniform stretchability can be obtained. Further, the polyolefin resin can contain ultra-high molecular weight polyethylene. When the polyolefin resin contains ultra-high molecular weight polyethylene, the Mw of the resulting polyolefin microporous membrane can be easily controlled within a specific range to be described later, and an excellent productivity such as excellent extrusion kneading characteristics, tends to be obtained. Since the types and the blending amounts of components which can be used as the polyolefin resin are the same as those described above, detailed descriptions thereof are omitted.

The melt-kneading can be carried out under such conditions that the ratio (a2/a1) of the weight fraction (a2) of the polyolefin having a molecular weight of 5×10⁵ or more in the resulting polyolefin microporous membrane, relative to the weight fraction (a1) of the polyolefin having a molecular weight of 5×10⁵ or more in the polyolefin resin to be used as a raw material, is preferably 40% or more, and more preferably 60% or more. When the ratio (a2/a1) is within the above described range, it is possible to prevent changes in the molecular weight distribution of the polyolefin resin to be used as a raw material during the production process of the polyolefin resin, and easily produce a polyolefin microporous membrane in which defects such as scratches and pinholes can be stably detected. The method of controlling the ratio (a2/a1) within the above described range is not particularly limited, and the ratio can be controlled within the above described range by appropriately adjusting the melt-kneading conditions to prevent the occurrence of oxidative degradation during the melt-kneading. The occurrence of oxidative degradation during the melt-kneading can be prevented, for example, by adding an antioxidant to the raw material, adjusting the number of revolution of the screw during the melt-kneading, carrying out the melt-kneading under an inert gas atmosphere and/or the like.

The resin solvent may contain a component other than the polyolefin resin and the membrane-forming solvent (solvent) such as, for example, a crystal nucleating agent or an antioxidant. The crystal nucleating agent is not particularly limited, and it is possible to use, for example, a known compound-based or fine particle-based crystal nucleating agent. The crystal nucleating agent may be used such that the crystal nucleating agent is mixed and dispersed in the polyolefin resin in advance, to prepare a master batch.

When the resin solution does not contain a nucleating agent, the polyolefin resin preferably contains ultra-high molecular weight polyethylene and high density polyethylene. Further, the resin solution may contain high density polyethylene, ultra-high molecular weight polyethylene and the nucleating agent. Incorporation of these components allows for a further improvement in the pin puncture strength.

Next, the resin solution is extruded and cooled to form a gel-like sheet. For example, the resin solution prepared as described above is supplied from the extruder to a die, and extruded in the form of a sheet to obtain a molding. The resulting extruded molding is cooled to obtain a gel-like sheet.

The gel-like sheet can be formed, for example, using any of the methods disclosed in JP 2132327 B and JP 3347835 B. The cooling is preferably carried out at a cooling rate of 50° C./min or more, at least until the gelation temperature is reached. The cooling is preferably carried out until the extruded molding is cooled to 25° C. or lower. By cooling the extruded molding, the microphase of the polyolefin separated by the membrane-forming solvent can be fixed. When the cooling rate is within the above described range, the degree of crystallinity can be maintained within a moderate range, and a gel-like sheet suitable for stretching can be obtained. The cooling can be carried out by a method of bringing the extruded molding into contact with a coolant such as cold blast or cooling water, a method of bringing the extruded molding into contact with a chill roll, or the like. However, the cooling is preferably carried out by bringing the extruded molding into contact with a roll cooled with a coolant.

Subsequently, the gel-like sheet is subjected to stretching. The stretching (first stretching) of the gel-like sheet is also referred to as wet stretching. The wet stretching is carried out at least uniaxially. The gel-like sheet can be stretched uniformly, due to containing the solvent. The gel-like sheet is preferably stretched at a predetermined draw ratio, after being heated, by a tenter method, a roll method, an inflation method, or any combination thereof. The wet stretching may be uniaxial stretching or biaxial stretching, but biaxial stretching is preferred. In biaxial stretching, any of simultaneous biaxial stretching, stepwise stretching and multistage stretching (for example, a combination of simultaneous biaxial stretching and stepwise stretching) may be performed.

The areal draw ratio (draw ratio by area) in the wet stretching, in uniaxial stretching, for example, is 3 times or more, and more preferably 4 times or more and 30 times or less. In biaxial stretching, the areal draw ratio is preferably 9 times or more, more preferably 16 times or more, and still more preferably 25 times or more. The upper limit of the areal draw ratio is preferably 100 times or less, and more preferably 64 times or less. Further, the draw ratios in the longitudinal direction (machine direction: MD direction) and the width direction (transverse direction: TD direction) are each preferably 3 times or more, and the draw ratios in the MD direction and the TD direction may be the same as, or different from, each other. When the draw ratio is adjusted to 5 times or more, an improvement in the pin puncture strength can be expected. The draw ratio as used in this step refers to the draw ratio of the gel-like sheet immediately before being subjected to the next step, relative to the gel-like sheet immediately before being subjected to this step. The TD direction is the direction orthogonal to the MD direction, when the microporous membrane is seen in a plane view.

The stretching temperature is preferably controlled within the range of from the crystal dispersion temperature (Tcd) of the polyolefin resin to the Tcd +30° C., more preferably within the range of from the crystal dispersion temperature (Tcd) +5° C. to the crystal dispersion temperature (Tcd) +28° C., and particularly preferably within the range of from the Tcd +10° C. to the Tcd +26° C. When the stretching temperature is within the above described range, membrane rupture due to the stretching of the polyolefin resin is prevented, thereby allowing for stretching at a high draw ratio. The crystal dispersion temperature as used herein refers to a value determined by measuring the temperature characteristics of dynamic viscoelasticity, in accordance with ASTM D4065. The ultra-high molecular weight polyethylene, the polyethylene other than the ultra-high molecular weight polyethylene and the polyethylene composition described above have a crystal dispersion temperature of about 90 to 100° C. Accordingly, the stretching temperature can be adjusted, for example, to 90° C. or higher and 130° C. or lower.

The stretching as described above causes cleavage between polyethylene crystal lamellae, resulting in the refinement of the polyethylene phase and the formation of a number of fibrils. The fibrils are connected irregularly and three-dimensionally to form a network structure (three-dimensional network structure). When the stretching conditions are adjusted within the above described ranges, it is possible to obtain a polyolefin microporous membrane having an improved mechanical strength.

Next, the membrane-forming solvent is removed from the gel-like sheet after wet stretching, to obtain a microporous membrane. The membrane-forming solvent is removed by washing with a washing solvent. Since the polyolefin phase in the gel-like sheet is separated from the membrane-forming solvent phase, the removal of the membrane-forming solvent allows for obtaining a microporous membrane. The resulting microporous membrane includes fibrils forming a three-dimensional network structure, and pores (voids) communicating three-dimensionally and irregularly. Removal of the washing solvent and the removal of the membrane-forming solvent using the washing solvent can be carried out by a known method, and it is possible to use, for example, any of the methods disclosed in JP 2132327 B and JP 2002-256099 A.

Subsequently, the microporous membrane after the removal of the solvent is subjected to drying. The microporous membrane after the removal of the membrane-forming solvent is dried by heat-drying or air-drying. The drying temperature is preferably equal to or lower than the crystal dispersion temperature (Tcd) of the polyolefin resin, and particularly preferably 5° C. or more lower than the Tcd. The drying is preferably carried out until the content of the residual washing solvent is reduced to 5% by mass or less, and more preferably 3% by mass or less, with respect to 100% by mass (dry weight) of the microporous membrane. When the content of the residual washing solvent is within the above described range, the porosity of the resulting polyolefin microporous membrane is improved when the dry stretching and heat treatment of the microporous membrane to be described later are carried out, and the deterioration of the permeability can be prevented.

Next, the microporous membrane after drying is subjected to stretching. The stretching (second stretching) of the microporous membrane after drying is also referred to as dry stretching. The microporous membrane after drying is dry stretched at least uniaxially. The dry stretching of the microporous membrane can be carried out by a tenter method or the like in the same manner as described above, while heating the membrane. The stretching may be uniaxial stretching or biaxial stretching. In biaxial stretching, either simultaneous biaxial stretching or stepwise stretching may be performed, but stepwise stretching is preferred. In stepwise stretching, it is preferred that the microporous membrane be stretched in the MD direction, and then stretched in the TD direction.

The dry stretching is carried out at an areal draw ratio (draw ratio by area) of 1.2 times or more, and this has an effect of improving the pin puncture strength and reducing the light transmittance. The areal draw ratio is more preferably 1.8 times or more and 9.0 times or less. In uniaxial stretching, for example, the lower limit value of the draw ratio in the MD direction or the TD direction is 1.2 times or more; and the upper limit value thereof is preferably 5.0 times or less, and more preferably 3.0 times or less. In biaxial stretching, the lower limit values of the draw ratios in the MD direction and the TD direction are each 1.0 times or more; and the upper limit values thereof are each preferably 5.0 times or less, and more preferably 3.0 times or less. The draw ratios in the MD direction and the TD direction may be the same as, or different from, each other. However, it is preferred that the draw ratios in the MD direction and the TD direction be substantially the same. In dry stretching, it is preferred that the microporous membrane be stretched at a draw ratio of more than 1 and not more than 3 times in the MD direction (second stretching), and then successively stretched at a draw ratio of more than 1 and not more than 5 times, and more preferably at a draw ratio of more than 1 and not more than 3 times in the TD direction (third stretching). The draw ratio as used in this step refers to the draw ratio of the microporous membrane immediately before being subjected to the next step, relative to the microporous membrane immediately before being subjected to this step. The stretching temperature in this step (dry stretching) is usually from 90 to 135° C., but not particularly limited thereto.

The microporous membrane sheet after drying may be subjected to a heat treatment. The heat treatment stabilizes crystals and makes lamellae uniform. The heat treatment can be carried out by a heat setting treatment and/or a heat relaxation treatment. The heat setting treatment refers to a heat treatment in which heating is carried out such that the size of the membrane in the TD direction is kept unchanged. The heat relaxation treatment refers to a heat treatment in which the membrane is heat-shrunk in the MD direction and/or the TD direction, during the heating. The heat setting treatment is preferably carried out by a tenter method or a roll method. For example, the heat relaxation treatment can be carried out by the method disclosed in JP 2002-256099 A. The heat treatment temperature is preferably within the range of from the Tcd to the Tm of the second polyolefin resin, for example, a temperature of 120° C. or higher and 135° C. or lower, and preferably 125° C. or higher and 133° C. or lower. The microporous membrane sheet may be stretched during the heat treatment, and the draw ratio is, for example, preferably 1.1 times or more and 5.0 times or less, and more preferably 1.3 times or more and 3.0 times or less. The stretching in the heat treatment is generally carried out in the TD direction. In carrying out stretching during the heat relaxation treatment, the draw ratio is, for example, 1.0 times or more and 4.0 times or less, and preferably 1.1 times or more and 2.5 times or less. The relaxation rate can be adjusted to 0% or more and 20% or less.

The final areal draw ratio in the resulting polyolefin microporous membrane is 50 times or more, preferably 70 times, and more preferably 75 times or more and 150 times or less the original area.

The polyolefin microporous membrane after dry stretching can further be subjected to a crosslinking treatment and a hydrophilization treatment. For example, the crosslinking treatment is carried out by irradiating ionizing radiation such as alpha-rays, beta-rays, gamma-rays, electron beams and the like to the microporous membrane. In electron beam irradiation, the electron beam is preferably irradiated with an electron dose of 0.1 to 100 Mrad, at an acceleration voltage of 100 to 300 kV. The crosslinking treatment increases the meltdown temperature of the microporous membrane. Further, the hydrophilization treatment can be carried out by monomer grafting, a surfactant treatment, corona discharge or the like. The monomer grafting is preferably carried out after the crosslinking treatment.

The polyolefin microporous membrane may be a monolayer membrane, but may have a structure in which one or more layers each composed of the polyolefin microporous membrane are laminated. Such a multilayer polyolefin microporous membrane can include two or more layers each composed of the polyolefin microporous membrane. In the multilayer polyolefin microporous membrane, the compositions of the polyolefin resins included in the respective layers may be the same as, or different from, each other.

The polyolefin microporous membrane may also be a laminated polyolefin porous membrane in which another porous layers(s) made of a material(s) other than the polyolefin resin is/are laminated on the polyolefin porous membrane. The other porous layer is not particularly limited. For example, a coating layer such as an inorganic particle layer containing a binder and an inorganic particle may be laminated on the polyolefin porous membrane. The binder component to be included in the inorganic particle layer is not particularly limited, and any known component can be used. Examples thereof include acrylic resins, polyvinylidene fluoride resins, polyamideimide resins, polyamide resins, aromatic polyamide resins and polyimide resins. The inorganic particle to be included in the inorganic particle layer is not particularly limited, and any known material can be used. Examples thereof include alumina, boehmite, barium sulfate, magnesium oxide, magnesium hydroxide, magnesium carbonate and silicon. Further, the laminated polyolefin porous membrane may be one in which the binder resin which has been porosified is laminated on at least one surface of the polyolefin microporous membrane.

### EXAMPLES

Our membranes and separators will now be described in further detail with reference to Examples. It is noted, however, that this disclosure is in no way limited to the Examples.

### Measurement Methods and Evaluation Methods

### Membrane Thickness

The membrane thickness was determined by measuring five points within an area of 95 mm×95 mm of the polyolefin microporous membrane, using a contact thickness gauge (Litematic, manufactured by Mitutoyo Corporation), and calculating the mean value of the measured values.

### Porosity

The porosity was determined according to the following equation comparing: the weight w₁ of the polyolefin microporous membrane; and the weight w2 of a non-porous polymer which is equivalent to the polyolefin microporous membrane (namely, a polymer having the same width, length and composition).

Porosity (%)=(w₂−w₁)/w₂×100

### Basis Weight

The basis weight was determined by measuring the weight of 25 cm² of the polyolefin microporous membrane.

### Tensile Strength

The MD tensile strength and the TD tensile strength were measured by a method in accordance with ASTM D882, using a test piece in the form of a strip having a width of 10 mm.

### Tensile Elongation

The tensile elongation was measured by a method in accordance with ASTM D-882A.

### Pin Puncture Strength

The pin puncture strength was determined by measuring the maximum load L₁ (N), when the polyolefin microporous membrane having a membrane thickness T₁ (μm) was punctured with a needle having a diameter of 1 mm and having a spherical tip (curvature radius R: 0.5 mm) at a speed of 2 mm/sec.

### Air Permeability

The air permeability was determined by measuring the air resistance P₁ (sec/100 cm³) of the polyolefin microporous membrane having a membrane thickness T₁ (μm), using an air permeability tester (EGO-1T, manufactured by Asahi Seiko Co., Ltd.), and in accordance with the Oken Tester Method defined in JIS P-8117.

### Heat Shrinkage in MD direction (MD heat shrinkage) and Heat Shrinkage in TD Direction (TD Heat Shrinkage)

The MD heat shrinkage and the TD heat shrinkage after heating at 105° C. for 8 hours were determined as follows.
(1) The lengths of a test piece of the polyolefin microporous membrane in both the MD and TD directions are measured at room temperature (25° C.).
(2) The test piece of the polyolefin microporous membrane is equilibrated at a temperature of 105° C. for 8 hours, without applying a load thereto.
(3) The lengths of the polyolefin microporous membrane in both the MD and TD directions are measured.
(4) The heat shrinkages in the MD direction and the TD direction were calculated by: dividing the respective measured values obtained in (3) by the respective measured values obtained in (1); subtracting each of the thus obtained values from 1; and representing the respective resulting values in percentage (%).

### Light Transmittance at 660 nm

Three samples each having a size of 5 cm×5 cm were cut out from three locations in the polyolefin microporous membrane, selected from the central portion in the TD direction and at random in the MD direction. Each sample was set on a transmission type laser discrimination sensor, IB-30, manufactured by Keyence Corporation such that a laser beam (laser wavelength: 660 nm) was vertically irradiated on the surface of the sample, and the light transmittance was measured at the center of the sample. Subsequently, the sample was rotated 90°, and the laser beam was vertically irradiated on the surface of the sample, and the light transmittance was measured at the center of the sample. The mean value of the measured values at six points obtained from the three samples was determined as the light transmittance at 660 nm. Weight Fraction of Polyolefin Having Molecular Weight of 5×10⁵ or More in Polyolefin Microporous Membrane, and Residual Rate of Polyolefin Having Molecular Weight of 5×10⁵

The molecular weights of the polyolefin resin used as a material (raw material) and the resulting polyolefin microporous membrane were measured by high temperature gel permeation chromatography (GPC), and a molecular weight distribution curve was prepared for each of the resin and the membrane.

From each of the thus obtained molecular weight distribution curves, the weight fraction of the polyolefin having a molecular weight of 5×10⁵ or more (the area corresponding to a molecular weight of 5×10⁵ or more, divided by the total area) was calculated to obtain the value of the weight fraction (a1) of the polyolefin having a molecular weight of 5×10⁵ or more in the raw material polyolefin resin, and the value of the weight fraction (a2) of the polyolefin having a molecular weight of 5×10⁵ or more in the resulting polyolefin microporous membrane. The residual rate of the polyolefin having a molecular weight of 5×10⁵ or more (%) was calculated according to the equation: [(a2/a1)×100]. The residual rate (%) of the resin material having a molecular weight of 5×10⁵ or more was evaluated according to the following criteria.
A: The residual rate is 40% or more.
B: The residual rate is 20% or more and less than 40%.
C: The residual rate is less than 20%.

The weight average molecular weights (Mws) of the polyolefin microporous membrane and the polyolefin resin were determined by gel permeation chromatography (GPC), under the following conditions.
Measuring apparatus: GPC-150C, manufactured by Waters Corporation
Column: Shodex UT806M, manufactured by Showa Denko K. K.
Column temperature: 135° C.
Solvent (mobile phase): o-dichlorobenzene
Solvent flow rate: 1.0 ml/min
Sample concentration: 0.1 wt% (dissolution conditions: 135° C./1 h)
Injection amount: 500 pi
Detector: a differential refractometer (RI detector), manufactured by Waters Corporation
Calibration curve: prepared from a calibration curve obtained using a monodisperse polystyrene standard sample, using a predetermined conversion constant (0.468)

### Evaluation of Detection of Scratches and Pinholes

Using a metal jig having a size of 0.5 mm in length and width, pinholes (through holes) and scratches having a depth of about 10% of the membrane thickness (non-penetrating dent scratches) (both of which are collectively referred to as “simulated defects”) were formed on the microporous membrane, to prepare a test piece. The resulting test piece was tested using an optical defect detector (IRIS, manufactured by Ayaha Corporation), to detect the simulated defects. The detectability of the simulated defects was evaluated according to the following criteria.
Good: The detectability of scratches and pinholes was 100%.
Poor: The detectability of scratches or pinholes was less than 100%.

### Example 1

A mixture of: 40 parts by weight of a ultra-high molecular weight polyethylene resin having a weight average molecular weight of 2.5×10⁶ and a melting point of 136° C.; and 60 parts by weight of a linear high density polyethylene resin having a weight average molecular weight of 3.5×10⁵, a melting point of 135° C., a ratio of weight average molecular weight/ number average molecular weight of 4.05, and an unsaturated end group content of 0.14/1.0×10⁴ carbon atoms; was introduced into a twin screw extruder, and liquid paraffin injected using a pump, through a side feeder of the twin screw extruder. The amount of liquid paraffin to be injected was adjusted such that the amount of the polyethylene resin mixture was 25% by weight with respect to 100% by weight of the total amount of the polyethylene resin composition and liquid paraffin. After the injection of liquid paraffin to the twin screw extruder, the resulting mixture was melt-kneaded, to obtain a mixed solution of the polyethylene resin mixture and liquid paraffin. The resulting mixed solution of the polyethylene resin mixture and liquid paraffin (membrane-forming solvent) was introduced into a single screw extruder, and then melt-extruded at a temperature of 210° C. The mixed solution was filtered with a filter obtained by sintering and compression of stainless steel fibers and having an average aperture of 20 μm, and then extruded through a T die in the form of a sheet, followed by cooling with a chill roll controlled to 20° C., to obtain a gel-like sheet. The gel-like sheet was simultaneously biaxially stretched by a tenter at 110° C., at a draw ratio of 5 times in both the TD direction and the MD direction. Thereafter, the stretched sheet was dipped in methylene chloride controlled to 25° C. to remove liquid paraffin, and then dried by blowing air at room temperature, to obtain a microporous film.

The resulting microporous film was re-stretched 1.8 times in the MD direction at 113° C. by a roll method using a longitudinal stretching machine, utilizing the difference in circumferential velocity of the rolls. Subsequently, the stretched microporous film was dry stretched 2.11 times in the TD direction, at a heat treatment temperature of 132.8° C., and then heat relaxed 3.8% in the TD direction, to obtain a polyolefin microporous membrane.

### Examples 2 to 5 and Comparative Examples 1 to 9

Polyolefin microporous membranes were produced in the same manner as in Example 1, except that the conditions shown in Tables 1 and 2 were used. The evaluation results and the like of the resulting polyolefin microporous membranes are shown in Tables 1 and 2.

TABLE 1

| | | | Unit | Example 1 | Example 2 | Example 3 | Example 4 | Example 5 |
|---|---|---|---|---|---|---|---|---|
| Production | Materials | UHMwPE | parts by | 40 | 40 | 40 | 40 | 40 |
| conditions | | | weight | | | | | |
| | | HDPE (parts by weight) | parts by | 60 | 60 | 60 | 60 | 60 |
| | | | weight | | | | | |
| | | Resin concentration | parts by | 25 | 25 | 25 | 25 | 25 |
| | | | weight | | | | | |
| | Wet | Biaxial stretching: temperature | ° C. | 110 | 110 | 110 | 110 | 110 |
| | Process | Biaxial stretching: draw ratio | times | 5 × 5 | 5 × 5 | 5 × 5 | 5 × 5 | 5 × 5 |
| | Re- | MD dry stretching: temperature | ° C. | 113 | 113 | 113 | 113 | 113 |
| | stretching | MD dry stretching: draw ratio | times | 1.8 | 1.55 | 1.55 | 1.65 | 1.55 |
| | Heat | Heat treatment: temperature | ° C. | 132.8 | 133.1 | 132.6 | 131.6 | 131.3 |
| | treatment | TD dry stretching: draw ratio | times | 2.11 | 2.05 | 2.05 | 2.05 | 1.87 |
| | | TD heat relaxation treatment: | % | 3.8 | 3.4 | 3.4 | 3.4 | 8.0 |
| | | relaxation rate | | | | | | |
| | | Total draw ratio in heat treatment | times | 2.03 | 1.98 | 1.98 | 1.98 | 1.72 |
| | | step | | | | | | |

| | | | | | | | |
|---|---|---|---|---|---|---|---|
| | Final draw ratio | times | 95.0 | 79.4 | 79.4 | 84.6 | 72.5 |
| Properties | Membrane thickness | μm | 3.4 | 2.8 | 4.1 | 4.2 | 5.1 |
| | Porosity | % | 34 | 30 | 37 | 43 | 45 |
| | Basis weight | g/m² | 2.2 | 1.9 | 2.6 | 2.4 | 2.8 |
| | Light transmittance at 660 nm | % | 35 | 38 | 30 | 31 | 26 |
| | Air permeability | sec/100 cm³ | 72 | 75 | 108 | 61 | 57 |
| | Pin puncture strength | N | 2.16 | 1.88 | 2.54 | 2.38 | 2.63 |
| | Pin puncture strength/basis weight | N/(g/m²) | 0.98 | 0.97 | 0.97 | 0.98 | 0.95 |
| | Heat shrinkage (105° C./8 h) MD | % | 2.8 | 3.3 | 3.1 | 3.4 | 3.7 |
| | Heat shrinkage (105° C./8 h) TD | % | 3.9 | 4.9 | 3.2 | 5.1 | 4.9 |
| | Tensile strength: MD | MPa | 392 | 360 | 336 | 324 | 283 |
| | Tensile elongation: MD | % | 63 | 81 | 89 | 75 | 88 |
| | Tensile strength: TD | MPa | 255 | 279 | 263 | 235 | 225 |
| | Tensile elongation: TD | % | 104 | 116 | 125 | 119 | 115 |

| | | | | | | |
|---|---|---|---|---|---|---|
| | Weight fraction of polyolefin having a | 5% or more | 5% or | 5% or more | 5% or | 5% or |
| | molecular weight of 5 × 10⁵ | | more | | more | more |
| | Residual rate of polyolefin having a molecular | A | A | A | A | A |
| | weight of 5 × 10⁵ | | | | | |
| Evaluation | Evaluation of detection of simulated defects | Good | Good | Good | Good | Good |

TABLE 2

| | | | | Com. | Com. | Com. | Com. | Com. | Com. | Com. | Com. | Com. |
|---|---|---|---|---|---|---|---|---|---|---|---|---|
| | | | Unit | Ex*. 1 | Ex. 2 | Ex. 3 | Ex. 4 | Ex. 5 | Ex. 6 | Ex. 7 | Ex. 8 | Ex. 9 |
| Production | Materials | UHMwPE | parts by weight | 40 | 40 | 18 | 40 | 40 | 18 | 40 | 30 | 30 |
| conditions | | HDPE (parts by | parts by weight | 60 | 60 | 82 | 60 | 60 | 82 | 60 | 70 | 70 |
| | | weight) | | | | | | | | | | |
| | | Resin concentration | parts by weight | 25 | 25 | 30 | 25 | 25 | 30 | 25 | 28.5 | 28.5 |
| | Wet | Biaxial stretching: | ° C. | 111.5 | 115 | 113 | 106 | 115 | 114 | 106.5 | 114 | 114 |
| | Process | temperature | | | | | | | | | | |
| | | Biaxial stretching: | times | 5 × 5 | 7 × 7 | 5 × 5 | 5 × 5 | 5 × 5 | 5 × 5 | 5 × 5 | 5 × 5 | 5 × 5 |
| | | draw ratio | | | | | | | | | | |
| | Re- | MD dry stretching: | ° C. | — | — | — | 113 | — | — | — | — | — |
| | stretching | temperature | | | | | | | | | | |
| | | MD dry stretching: | times | — | — | — | 1.4 | — | — | — | — | — |
| | | draw ratio | | | | | | | | | | |
| | Heat | Heat treatment: | ° C. | 127 | 127.9 | 129.8 | 132.5 | 130.4 | 131.6 | 127.1 | 128.6 | 127.1 |
| | treatment | temperature | | | | | | | | | | |
| | | TD dry stretching: | times | 1.6 | 1.6 | 1.4 | 1.63 | 1.4 | 1.36 | 1.41 | 1.2 | 1.0 |
| | | draw ratio | | | | | | | | | | |
| | | TD heat relaxation | % | 8.1 | 6.3 | 3.6 | 8.0 | 2.1 | 2.9 | 6.4 | 0.0 | 0.0 |
| | | treatment: relaxation | | | | | | | | | | |
| | | rate | | | | | | | | | | |
| | | Total draw ratio in | times | 1.47 | 1.5 | 1.35 | 1.5 | 1.37 | 1.32 | 1.32 | 1.2 | 1.0 |
| | | heat treatment step | | | | | | | | | | |

| | | | | | | | | | | | |
|---|---|---|---|---|---|---|---|---|---|---|---|
| | Final draw ratio | times | 40.0 | 78.4 | 35.0 | 40.8 | 35.0 | 34.0 | 35.3 | 30.0 | 25.0 |
| Properties | Membrane thickness | μm | 3.3 | 3.0 | 3.1 | 5.3 | 5.5 | 7.1 | 6.8 | 19.2 | 22.9 |
| | Porosity | % | 40 | 40 | 29 | 36 | 35 | 30 | 40 | 45 | 38 |
| | Basis weight | g/m² | 1.9 | 1.8 | 2.2 | 3.7 | 3.6 | 4.9 | 4.0 | 10.5 | 14.0 |
| | Light transmittance at 660 nm | % | 43 | 48 | 41 | 5 | 5 | 2 | 5 | 0.5 | 0.4 |
| | Air permeability | sec/100 cm³ | 45 | 48 | 60 | 141 | 99 | 179 | 94 | 237 | 522 |
| | Pin puncture strength | N | 1.62 | 1.94 | 1.19 | 2.25 | 2.25 | 2.41 | 2.39 | 5.64 | 6.79 |
| | Pin puncture strength/basis weight | N/(g/m²) | 0.84 | 1.07 | 0.54 | 0.61 | 0.63 | 0.49 | 0.60 | 0.54 | 0.49 |
| | Heat shrinkage (105° C./8 h): MD | % | 9.3 | 11.4 | 3.6 | 2.4 | 4.4 | 3.8 | 4.9 | 5.1 | 6.5 |
| | Heat shrinkage (105° C./8 h): TD | % | 2.7 | 4.3 | 1.8 | 1.5 | 3.2 | 2.3 | 2.2 | 5.8 | 5.0 |
| | Tensile strength: MD | MPa | 193 | 217 | 179 | 223 | 186 | 159 | 172 | 158 | 180 |
| | Tensile elongation: MD | % | 97 | 80 | 150 | 85 | 135 | 164 | 162 | 176 | 182 |
| | Tensile strength: TD | MPa | 242 | 256 | 207 | 190 | 220 | 202 | 199 | 156 | 156 |
| | Tensile elongation: TD | % | 68 | 64 | 127 | 119 | 120 | 134 | 138 | 201 | 255 |
| | Weight fraction of polyolefin | | 2 to | 2 to | 0.1 to | 2 to | 2% or | 0.1 to | 0.1 to | 0.1 to | 1% or |
| | having a molecular weight | | 5% | 5% | 2% | 5% | more | 2% | 2% | 2% | more |
| | of 5 × 10⁵ | | | | | | | | | | |
| | Residual rate of polyolefin having | | B | B | B | B | B | B | C | B | B |
| | a molecular weight of 5 × 10⁵ | | | | | | | | | | |

| | | | | | | | | | | |
|---|---|---|---|---|---|---|---|---|---|---|
| Evaluation | Evaluation of detection of simulated defects | Poor | Poor | Poor | Good | Good | Good | Good | Good | Good |

*Com. Ex.: Comparative Example

### Evaluation

The polyolefin microporous membranes of Examples have a light transmittance at 660 nm of 40% or less when having a basis weight of 3.0 g/m² or less or a membrane thickness of 4 μm or less, and it was possible to stably detect the scratches and pinholes in the membranes, in the evaluation of detection of scratches and pinholes.

On the other hand, in the polyolefin microporous membranes of Comparative Examples 1 to 3, in which the light transmittance at 660 nm is more than 40% despite having a basis weight of 3.0 g/m² or less or a membrane thickness of 4 μm or less, we confirmed that some of the scratches and pinholes fail to be detected in the evaluation of detection of scratches and pinholes.

Further, as described above, the polyolefin microporous membranes of Comparative Examples 4 to 9 have a low light transmittance due to having a basis weight of more than 3.0 g/m² or a membrane thickness of more than 4 and we confirmed that the scratches and pinholes can be detected by a conventional optical defect inspection.

### INDUSTRIAL APPLICABILITY

The polyolefin microporous membrane can be suitably used as a battery separator because defects such as scratches and pinholes therein can be stably detected, even when the membrane has a reduced thickness or a higher porosity.

1-7. (canceled)

8. A polyolefin microporous membrane having a light transmittance at a wavelength of 660 nm of 40% or less, and satisfying at least one of (1) and (2):
(1) the basis weight is 3.0 g/m² or less; and
(2) the membrane thickness is 4 μm or less.

9. The polyolefin microporous membrane according to claim 8, having a pin puncture strength per 1 g/m² of basis weight of 0.75 N or more.

10. The polyolefin microporous membrane according to claim 8, containing 50% by mass or more of polyethylene.

11. The polyolefin microporous membrane according to claim 8, having a tensile strength in the MD direction of 240 MPa or more, and a tensile elongation in the MD direction of 50% or more.

12. A multilayer polyolefin microporous membrane comprising as at least one layer thereof, said polyolefin microporous membrane according to claim 8.

13. A laminated polyolefin microporous membrane comprising: said polyolefin microporous membrane according to claim 8; and one or more coating layers provided on at least one surface of said microporous membrane.

14. A battery comprising a separator including said polyolefin microporous membrane according to claim 8.

15. A battery comprising a separator including said multilayer polyolefin microporous membrane according to claim 12.

16. A battery comprising a separator including said laminated polyolefin microporous membrane according to claim 13.

17. The polyolefin microporous membrane according to claim 9, containing 50% by mass or more of polyethylene.

18. The polyolefin microporous membrane according to claim 9, having a tensile strength in the MD direction of 240 MPa or more, and a tensile elongation in the MD direction of 50% or more.

19. The polyolefin microporous membrane according to claim 10, having a tensile strength in the MD direction of 240 MPa or more, and a tensile elongation in the MD direction of 50% or more.

20. A multilayer polyolefin microporous membrane comprising as at least one layer thereof, said polyolefin microporous membrane according to claim 9.

21. A multilayer polyolefin microporous membrane comprising as at least one layer thereof, said polyolefin microporous membrane according to claim 10.

22. A multilayer polyolefin microporous membrane comprising as at least one layer thereof, said polyolefin microporous membrane according to claim 11.

23. A laminated polyolefin microporous membrane comprising: said polyolefin microporous membrane according to claim 9; and one or more coating layers provided on at least one surface of said microporous membrane.

24. A laminated polyolefin microporous membrane comprising: said polyolefin microporous membrane according to claim 10; and one or more coating layers provided on at least one surface of said microporous membrane.

25. A laminated polyolefin microporous membrane comprising: said polyolefin microporous membrane according to claim 11; and one or more coating layers provided on at least one surface of said microporous membrane.
